(19) United States
(12) Patent Application Publication
(10) Pub. No.: US 2022/0027401 A1
(43) Pub. Date: Jan. 27, 2022

(54) ONTOLOGY GENERATION SYSTEM, ONTOLOGY GENERATION METHOD, AND COMPUTER READABLE MEDIUM

(71) Applicant: MITSUBISHI ELECTRIC CORPORATION, Tokyo (JP)

(72) Inventors: Takuma ORIMOTO, Tokyo (JP); Ikumi MORI, Tokyo (JP)

(73) Assignee: MITSUBISHI ELECTRIC CORPORATION, Tokyo (JP)

(21) Appl. No.: 17/493,472

(22) Filed: Oct. 4, 2021

Related U.S. Application Data
(63) Continuation of application No. PCT/JP2019/019905, filed on May 20, 2019.

(51) Int. Cl. G06F 16/36; G06F 11/34; G06K 9/62

(52) U.S. Cl. CPC G06F 16/367; G06K 9/6215; G06F 11/3428; G06F 16/374

(57) ABSTRACT

A similarity degree computation unit (211) computes a similarity degree between each of one or more partial ontologies in a first-system-oriented ontology and a benchmark ontology of a second system, as a similarity degree of each of the partial ontologies. A candidate extraction unit (212) extracts as an ontology candidate from the first-system-oriented ontology, a set of: each of partial ontologies having similarity degrees which satisfy a similarity degree condition; and a partial ontology for linking to each other the partial ontologies having the similarity degrees which satisfy the similarity degree condition. An ontology output unit (214) outputs, when the ontology candidate satisfies a constraint condition, the ontology candidate as a second-system-oriented ontology.

### CROSS REFERENCE TO RELATED APPLICATION

This application is a Continuation of PCT International Application No. PCT/JP2019/019905, filed on May 20, 2019, which is hereby expressly incorporated by reference into the present application.

### TECHNICAL FIELD

The present invention relates to a technique for generating an ontology to be used in a computer system.

### BACKGROUND ART

In the IoT, information on various things is accumulated in a cloud as big data, and an application at each of a plurality of domains uses the big data. It is desirable that the big data can be used without paying attention to knowledge (domain knowledge) on a domain where a thing belongs. An example of the thing is a sensor. Examples of the domain knowledge are an installation place, a type of collected data, and accuracy.

IoT stands for Internet of Things.

Application stands for application program.

There exists an organization called one M2M as a standardizing body regarding the IoT.

one M2M has carried out standardization of a horizontally integrated IoT platform.

The horizontally integrated IoT platform accepts a semantic query from an application, and responds to the application. For example, this technique manages sensor data to which annotation based on an ontology is given, and realizes a response for the semantic query of the application by an inference equipment. Consequently, the application can use the sensor data without paying attention to the domain knowledge of the sensor.

Patent Literature 1 discloses a technique of suppressing deterioration of matching accuracy between metadata on a sensor side and metadata on an application side.

### CITATION LIST

### Patent Literature

Patent Literature 1: JP2018-81377A

### SUMMARY OF INVENTION

### Technical Problem

In a conventional horizontally integrated IoT platform, it is assumed that an ontology is used to realize a semantic technique. Further, in order to integrate a plurality of domains, it is assumed that the ontology is installed on a cloud which has abundant resources.

Therefore, if the application cannot tolerate delay in communication with the cloud, it is difficult for the application to use the conventional horizontally integrated IoT platform. Further, Patent Literature 1 does not disclose a technique for resolving such a problem.

The present invention aims to generate an ontology which can be used in a system which does not have abundant resources.

### Solution to Problem

An ontology generation system according to the present invention includes:

a similarity degree computation unit to compute a similarity degree between each of one or more partial ontologies in a first-system-oriented ontology and a benchmark ontology of a second system, as a similarity degree of each of the partial ontologies;

a candidate extraction unit to extract as an ontology candidate from the first-system-oriented ontology, a set of: each of partial ontologies having similarity degrees which satisfy a similarity degree condition; and a partial ontology for linking to each other the partial ontologies having the similarity degrees which satisfy the similarity degree condition;

a constraint determination unit to determine whether or not the ontology candidate satisfies a constraint condition; and

an ontology output unit to output, when the ontology candidate satisfies the constraint condition, the ontology candidate as a second-system-oriented ontology.

### Advantageous Effects of Invention

According to the present invention, it is possible to generate an ontology (a second-system-oriented ontology) for a system which does not have abundant resources, based on an ontology (a first-system-oriented ontology) for a system which has abundant resources.

### BRIEF DESCRIPTION OF DRAWINGS

FIG. 1 is a configuration diagram of an IoT system 100 according to a first embodiment;

FIG. 2 is a configuration diagram of an ontology generation apparatus 200 according to the first embodiment;

FIG. 3 is a configuration diagram of a storage unit 290 according to the first embodiment;

FIG. 4 is a flowchart of an ontology generation method according to the first embodiment;

FIG. 5 is a flowchart of a similarity degree computation process (S110) according to the first embodiment;

FIG. 6 is a diagram illustrating a benchmark ontology (A) according to the first embodiment;

FIG. 7 is a diagram illustrating a cloud-system-oriented ontology 291 according to the first embodiment;

FIG. 8 is a diagram illustrating thesaurus data 293A according to the first embodiment;

FIG. 9 is a diagram illustrating an ontology candidate (A) according to the first embodiment;

FIG. 10 is a configuration diagram of an ontology generation apparatus 200 according to a second embodiment;

FIG. 11 is a configuration diagram of a storage unit 290 according to the second embodiment;

FIG. 12 is a flowchart of an ontology generation method according to the second embodiment;

FIG. 13 is a flowchart of a similarity degree type selection process (S210) according to the second embodiment;

FIG. 14 is a diagram illustrating similarity degree type data 296 according to the second embodiment;

FIG. 15 is a diagram illustrating thesaurus data 293A according to the second embodiment;

FIG. 16 is a configuration diagram of an ontology generation apparatus 200 according to a third embodiment;

FIG. 17 is a flowchart of an ontology generation method according to the third embodiment;

FIG. 18 is a flowchart of a similarity degree computation process (S310) according to the third embodiment;

FIG. 19 is a diagram illustrating a morpheme similarity degree according to the third embodiment;

FIG. 20 is a configuration diagram of an ontology generation apparatus 200 according to a fourth embodiment;

FIG. 21 is a configuration diagram of a storage unit 290 according to the fourth embodiment;

FIG. 22 is a flowchart of an ontology generation method according to the fourth embodiment;

FIG. 23 is a diagram illustrating a part of a cloud-system-oriented ontology 291 according to the fourth embodiment;

FIG. 24 is a diagram illustrating a benchmark ontology (A) according to the fourth embodiment;

FIG. 25 is a diagram illustrating an ontology candidate (A) according to the fourth embodiment;

FIG. 26 is a diagram illustrating an ontology candidate-after-synthesis according to the fourth embodiment;

FIG. 27 is a configuration diagram of an IoT system 100 according to a fifth embodiment;

FIG. 28 is a configuration diagram of an ontology change apparatus 300 according to the fifth embodiment;

FIG. 29 is a configuration diagram of a storage unit 390 according to the fifth embodiment;

FIG. 30 is a flowchart of an ontology change method according to the fifth embodiment;

FIG. 31 is a diagram illustrating statistics data 392 according to the fifth embodiment;

FIG. 32 is a diagram illustrating a reduced ontology (A) according to the fifth embodiment;

FIG. 33 is a configuration diagram of an ontology change apparatus 300 according to a sixth embodiment;

FIG. 34 is a flowchart of an ontology change method according to the sixth embodiment;

FIG. 35 is a diagram illustrating statistics data 392 according to the sixth embodiment;

FIG. 36 is a hardware configuration diagram of the ontology generation apparatus 200 according to the embodiments; and

FIG. 37 is a hardware configuration diagram of the ontology change apparatus 300 according to the embodiments.

### DESCRIPTION OF EMBODIMENTS

In the embodiments and the drawings, the same reference numerals are assigned to the same elements or corresponding elements. Descriptions of elements assigned with the same reference numerals as the described elements will be omitted or simplified as appropriate. Arrows in the drawings mainly indicate flows of data or flows of processes.

### First Embodiment

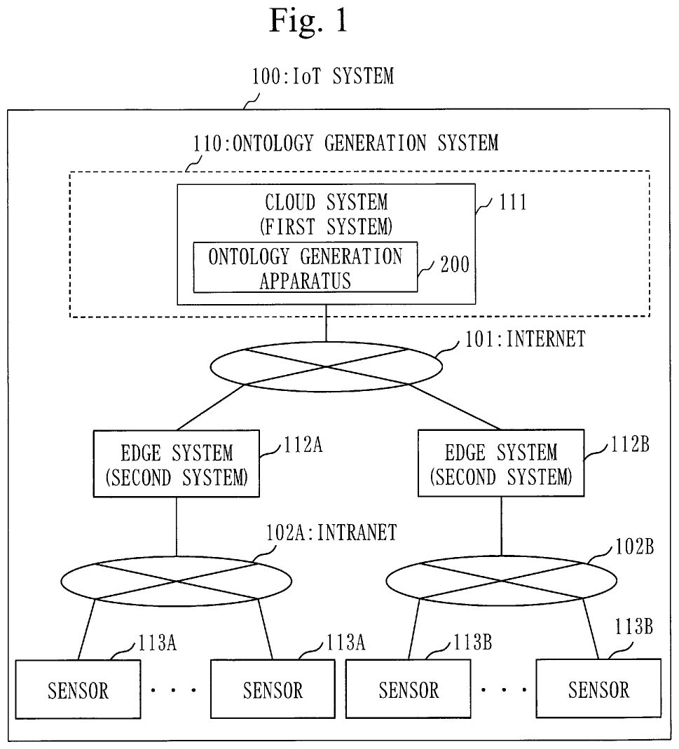

A mode of generating an ontology for a system which does not have abundant resources will be described with reference to FIGS. 1 to 9.

### Description of Configuration

A configuration of an IoT system 100 will be described with reference to FIG. 1.

The IoT system 100 is an information processing system which uses the IoT. The information processing system is a computer system, and includes one or more computers.

The IoT system 100 includes a cloud system 111 (an example of a first system).

The IoT system 100 includes one or more edge systems (112A or/and 112B). When neither the edge system 112A nor the edge system 112B is specified, each one is referred to as an edge system 112 (an example of a second system).

The IoT system 100 includes one or more sensors (113A or/and 113B). The sensor 113A is a sensor which belongs to the same domain as the edge system 112A. The sensor 113B is a sensor which belongs to the same domain as the edge system 112B. When neither sensor is specified, each one is referred to as a sensor 113.

The IoT system 100 includes one or more intranets (102A or/and 102B). The intranet 102A is an intranet which belongs to the same domain as the edge system 112A. The intranet 102B is an intranet which belongs to the same domain as the edge system 112B. When neither the intranet 102A and the intranet 102B is specified, each one is referred to as an intranet 102. The intranet 102 is an example of a communication network.

The cloud system 111 is an information processing system called “cloud”. For example, the cloud system 111 manages big data.

The cloud system 111 has abundant resources capable of executing an information process requiring a high load.

The edge system 112 is an information processing system which uses the cloud system 111, and has no abundant resources. For example, an application incorporated into the edge system 112 uses the big data accumulated in the cloud system 111, and performs each type of information process.

The edge system 112 does not have such abundant resources as the cloud system 111.

The edge system 112 communicates with the one or more sensors 113 via the intranet 102. Specifically, the edge system 112 collects pieces of sensor data from the one or more sensors 113.

The edge system 112 communicates with the cloud system 111 via the Internet 101. Specifically, the edge system 112 transmits the collected pieces of sensor data to the cloud system 111. Each piece of sensor data is used as a part of the big data. The Internet 101 is an example of the communication network.

The cloud system 111 includes an ontology generation apparatus 200, and realizes an ontology generation system 110.

The ontology generation system 110 generates an ontology for each edge system 112.

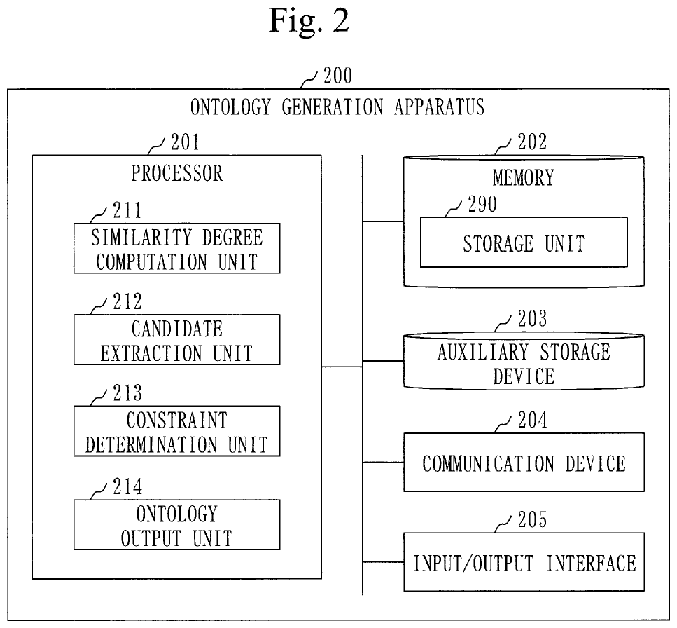

A configuration of the ontology generation apparatus 200 will be described with reference to FIG. 2.

The ontology generation apparatus 200 is a computer which includes pieces of hardware such as a processor 201, a memory 202, an auxiliary storage device 203, a communication device 204, and an input/output interface 205. These pieces of hardware are connected with each other via signal lines.

The processor 201 is an IC, which performs a calculation process, and controls the other pieces of hardware. For example, the processor 201 is a CPU, a DSP, or a GPU.

IC stands for Integrated Circuit.

CPU stands for Central Processing Unit.

DSP stands for Digital Signal Processor.

GPU stands for Graphics Processing Unit.

The memory 202 is a volatile storage device. The memory 202 is also called a main storage device or a main memory. For example, the memory 202 is a RAM.

Data stored in the memory 202 is stored in the auxiliary storage device 203 as necessary.

RAM stands for Random Access Memory.

The auxiliary storage device 203 is a non-volatile storage device. For example, the auxiliary storage device 203 is a ROM, an HDD, or a flash memory. Data stored in the auxiliary storage device 203 is loaded into the memory 202 as necessary.

ROM stands for Read Only Memory.

HDD stands for Hard Disk Drive.

The communication device 204 is a receiver or a transmitter. For example, the communication device 204 is a communication chip or an NIC.

NIC stands for Network Interface Card.

The input/output interface 205 is a port to which an input device and an output device are connected. For example, the input/output interface 205 is a USB terminal, the input devices are a keyboard and a mouse, and the output device is a display. USB stands for Universal Serial Bus.

The ontology generation apparatus 200 includes elements such as a similarity degree computation unit 211, a candidate extraction unit 212, a constraint determination unit 213, and an ontology output unit 214. These elements are realized by software.

The auxiliary storage device 203 stores an ontology generation program for causing a computer to function as the similarity degree computation unit 211, the candidate extraction unit 212, the constraint determination unit 213, and the ontology output unit 214. The ontology generation program is loaded into the memory 202, and executed by the processor 201.

The auxiliary storage device 203 further stores an OS. At least a part of the OS is loaded into the memory 202, and executed by the processor 201.

The processor 201 executes the ontology generation program while executing the OS.

OS stands for Operating System.

Input/output data of the ontology generation program is stored in a storage unit 290.

The memory 202 functions as the storage unit 290. However, storage devices such as the auxiliary storage device 203, a register in the processor 201, and a cash memory in the processor 201 may function as the storage unit 290 instead of the memory 202 or together with the memory 202.

The ontology generation apparatus 200 may include a plurality of processors which substitute for the processor 201. The plurality of processors share a roll of the processor 201.

The ontology generation program can be recorded (stored) in a volatile recording medium such as an optical disk or a flash memory in a computer-readable manner.

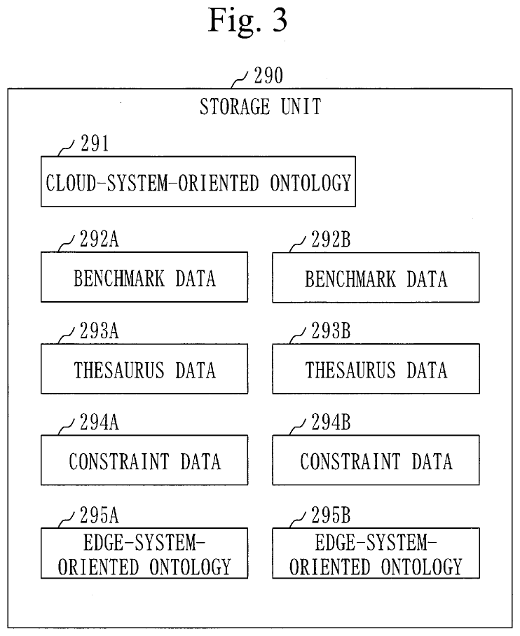

An example of data stored in the storage unit 290 will be described with reference to FIG. 3.

The storage unit 290 stores a cloud-system-oriented ontology 291 (an example of a first-system-oriented ontology) in advance.

The cloud-system-oriented ontology 291 is an ontology used in the cloud system 111.

The storage unit 290 stores for each edge system 112, benchmark data 292, thesaurus data 293, and constraint data 294 in advance.

The benchmark data 292 of the edge system 112A is referred to as benchmark data 292A, and the benchmark data 292 of the edge system 112B is referred to as benchmark data 292B. When neither the benchmark data 292A nor 292B is specified, each one is referred to as the benchmark data 292.

The thesaurus data 293 for the edge system 112A is referred to as thesaurus data 293A, and the thesaurus data 293 for the edge system 112B is referred to as thesaurus data 293B. When neither the thesaurus data 293A nor the thesaurus data 293B is specified, each one is referred to as the thesaurus data 293.

The constraint data 294 for the edge system 112A is referred to as constraint data 294A, and the constraint data 294 for the edge system 112B is referred to as constraint data 294B. When neither the constraint data 294A nor the constraint data 294B is specified, each one is referred to as the constraint data 294.

Details of each of the benchmark data 292, the thesaurus data 293, and the constraint data 294 will be described later.

The storage unit 290 stores an edge-system-oriented ontology 295 (an example of a second-system-oriented ontology) for each edge system 112.

The edge-system-oriented ontology 295 is an ontology generated for the edge system 112.

An ontology generated for the edge system 112A is referred to as an edge-system-oriented ontology 295A, and an ontology generated for the edge system 112B is referred to as an edge-system-oriented ontology 295B. When neither the edge-system-oriented ontology 295A nor the edge-system-oriented ontology 295B is specified, each one is referred to as the edge-system-oriented ontology 295.

The edge-system-oriented ontology 295 is generated based on the cloud-system-oriented ontology 291, the benchmark data 292, the thesaurus data 293, and the constraint data 294.

Details of the edge-system-oriented ontology 295 will be described later.

### Description of Operation

A procedure of operation of the ontology generation system 110 corresponds to an ontology generation method. Further, the procedure of the operation of the ontology generation system 110 corresponds to a procedure of a process of the ontology generation program.

The ontology generation method is implemented for each edge system 112.

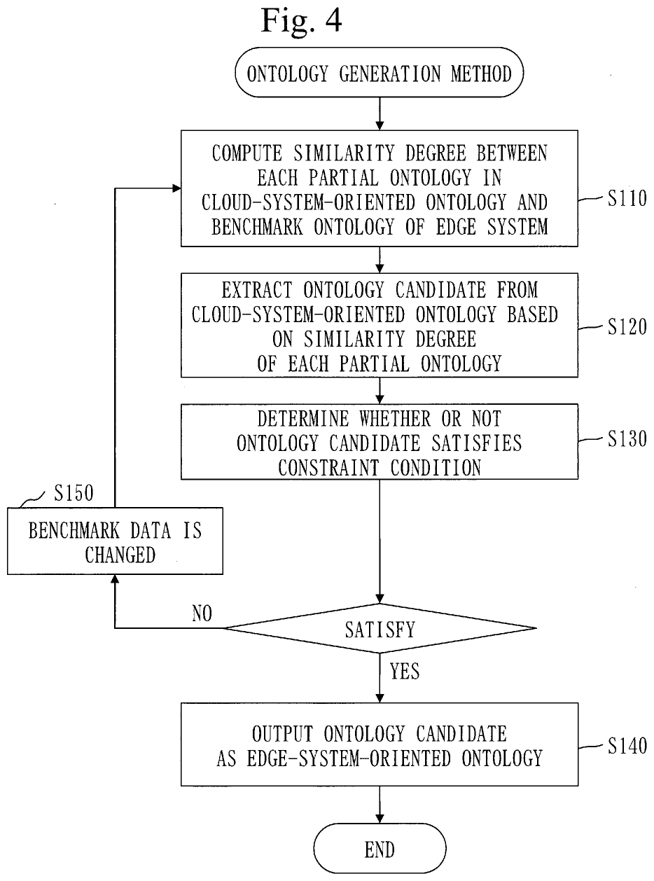

The ontology generation method for the edge system 112A will be described with reference to FIG. 4.

The ontology generation method for the edge system 112B is the same as the ontology generation method for the edge system 112A.

In step S110, the similarity degree computation unit 211 computes a similarity degree between each of one or more partial ontologies in the cloud-system-oriented ontology 291 and a benchmark ontology of the edge system 112A. Each similarity degree to be computed is referred to as a similarity degree of each partial ontology. Each partial ontology in the cloud-system-oriented ontology 291 is a part of the cloud-system-oriented ontology 291.

The benchmark ontology of the edge system 112A is referred to as a benchmark ontology (A).

The benchmark ontology (A) is an ontology indicated by the benchmark data 292A.

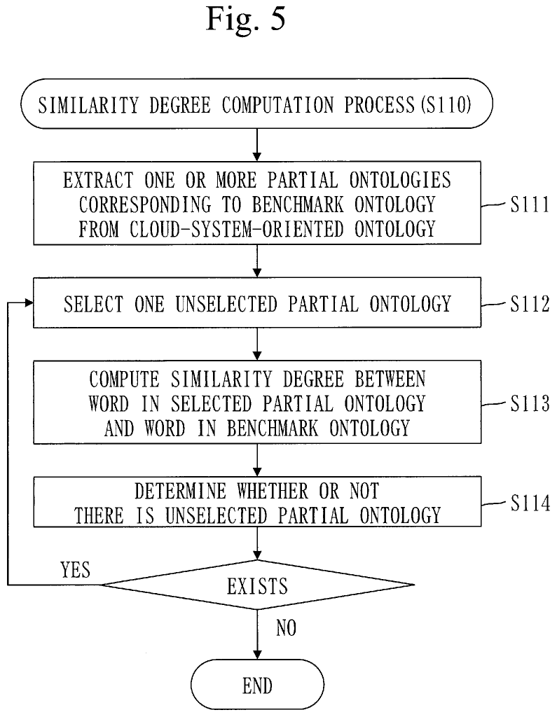

A procedure of a similarity degree computation process (S110) will be described with reference to FIG. 5.

In step S111, the similarity degree computation unit 211 extracts from the cloud-system-oriented ontology 291, one or more partial ontologies corresponding to the benchmark ontology (A).

A form of each partial ontology to be extracted matches a form of the benchmark ontology.

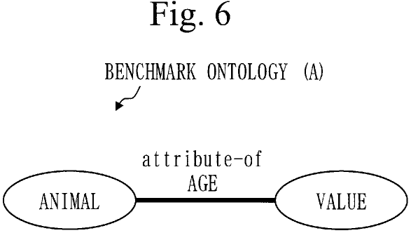

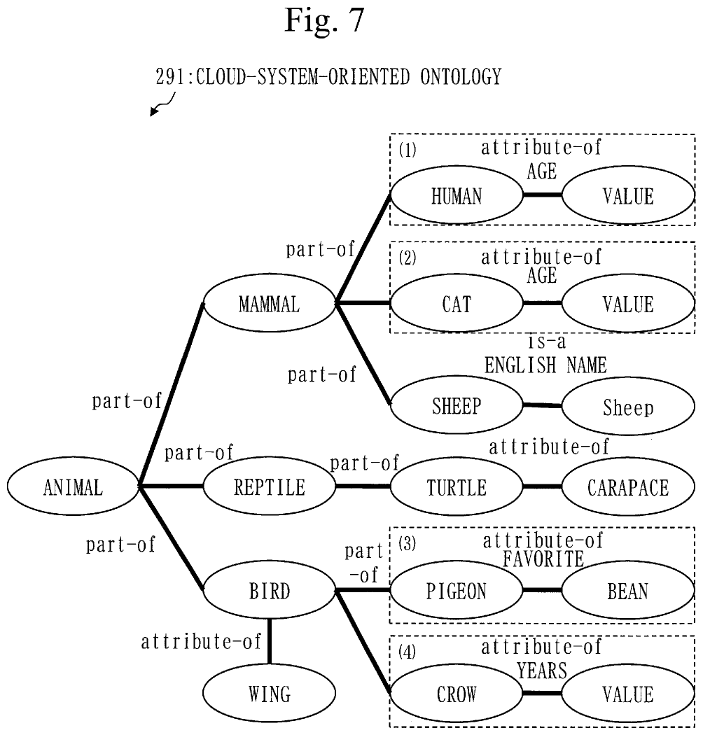

A specific example of step S111 will be described with reference to FIGS. 6 and 7.

FIG. 6 illustrates a specific example of the benchmark ontology (A).

The benchmark ontology (A) indicates a pair of nodes having a relation expressed in a form which is “attribute-of [a word]”. Specifically, the benchmark ontology (A) indicates a pair of an “animal” node and a “value” node. There is a relation which is “attribute-of age”, between the “animal” node and the “value” node.

FIG. 7 illustrates a specific example of the cloud-system-oriented ontology 291. Parts surrounded by dotted lines are the partial ontologies corresponding to the benchmark ontology (A).

The cloud-system-oriented ontology 291 includes four pairs of nodes having a relation indicated in the benchmark ontology (A), that is the relation expressed in a form which is “attribute-of [a word]”. A pair of nodes (1) is a pair of a “human” node and a “value” node. A pair of nodes (2) is a pair of a “cat” node and a “value” node. A pair of nodes (3) is a pair of a “pigeon” node and a “bean” node. A pair of nodes (4) is a pair of a “crow” node and a “value” node.

In this case, the similarity degree computation unit 211 extracts from the cloud-system-oriented ontology 291, four partial ontologies (1 to 4) corresponding to the four pairs of nodes (1 to 4). Each partial ontology to be extracted is a smallest part including a corresponding pair of nodes.

Returning to FIG. 5, descriptions will be continued from step S112.

In step S112, the similarity degree computation unit 211 selects one unselected partial ontology from the one or more partial ontologies extracted in step S111.

In step S113, the similarity degree computation unit 211 computes the similarity degree between a word in the partial ontology selected in S112 and a word in the benchmark ontology (A). The similarity degree to be computed is the similarity degree of the partial ontology selected in step S112.

Specifically, the similarity degree computation unit 211 computes the similarity degree by using the thesaurus data 293A. The thesaurus data 293A indicates a thesaurus for a word in the benchmark ontology (A). The thesaurus is one or more synonyms.

For example, when the word in the partial ontology matches the word in the benchmark ontology (A), the similarity degree of the partial ontology is “1”. Further, when the word in the partial ontology does not match the word in the benchmark ontology (A), but is included in the thesaurus data 293A, the similarity degree of the partial ontology is computed by calculating an equation of “similarity degree=1/the number of synonyms”. “The number of synonyms” means the number of synonyms indicated in the thesaurus data 293A. When the word in the partial ontology does not match the word in the benchmark ontology (A), and is not included in the thesaurus data 293A, the similarity degree of the partial ontology is “0”.

A specific example of step S112 will be described with reference to FIGS. 6 to 8.

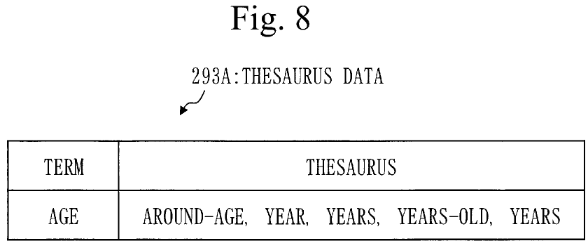

FIG. 8 illustrates a specific example of the thesaurus data 293A.

In FIG. 6, the relation in the benchmark ontology (A) includes a word “age”.

In FIG. 7, a relation in a partial ontology (1) and a relation in a partial ontology (2) include a word “age”. Further, a relation in a partial ontology (3) includes a word “favorite”, and a relation in a partial ontology (4) includes a word “years”.

The word “age” in the relation in the partial ontology (1) and the relation in the partial ontology (2) matches the word “age” in the relation in the benchmark ontology (A). Therefore, the similarity degree of each of the partial ontologies (1) and (2) is “1”.

The word “favorite” in the relation in the partial ontology (3) does not match the word “age” in the relation in the benchmark ontology (A). Further, the word “favorite” is not included in the thesaurus data 293A (see FIG. 8). Therefore, the similarity degree of the partial ontology (3) is “0”.

The word “years” in the relation in the partial ontology (4) does not match the word “age” in the relation in the benchmark ontology (A) but is included in the thesaurus data 293A (see FIG. 8). The number of synonyms indicated in the thesaurus data 293A is “5”. Therefore, the similarity degree of the partial ontology (4) is “0.2(=⅕)”.

Returning to FIG. 5, descriptions will be continued from step S114.

In step S114, the similarity degree computation unit 211 determines whether or not there is an unselected partial ontology in the one or more partial ontologies extracted in step S111.

If there is the unselected partial ontology, the process proceeds to step S112.

If there is no unselected partial ontology, the process ends.

Returning to FIG. 4, descriptions will be continued from step S120.

In step S120, the candidate extraction unit 212 extracts a candidate for the edge-system-oriented ontology 295A from the cloud-system-oriented ontology 291 based on the similarity degree of each of the one or more partial ontologies in the cloud-system-oriented ontology 291. The extracted candidate is referred to as an ontology candidate (A).

The ontology candidate (A) is a set of the one or more applicable partial ontologies and a linking partial ontology.

Each of the applicable partial ontologies is each of the partial ontologies that have similarity degrees satisfying a similarity degree condition (A).

The linking partial ontology is a partial ontology for linking the applicable partial ontologies to each other.

The similarity degree condition (A) is a similarity degree condition used for the edge system 112A, and is indicated in the benchmark data 292A. The similarity degree condition is a condition regarding the similarity degree.

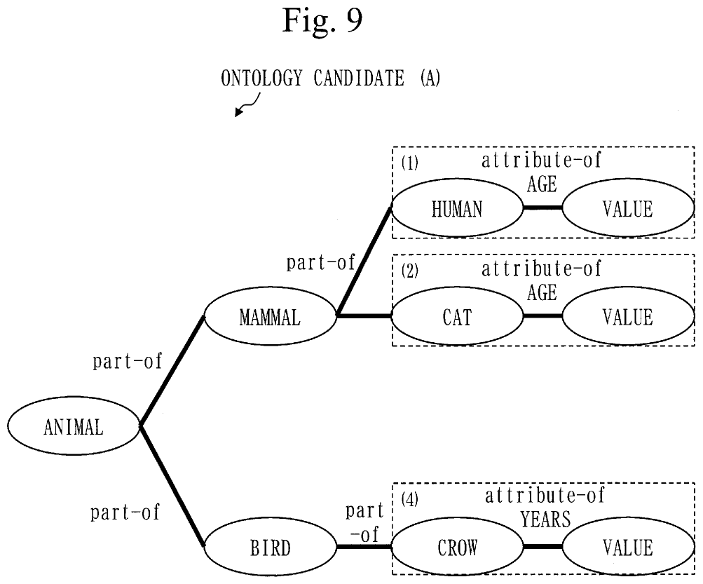

A specific example of step S120 will be described with reference to FIGS. 7 and 9.

FIG. 9 indicates a specific example of the ontology candidate (A).

In FIG. 7, the similarity degree of each of the partial ontologies (1) and (2) is “1”. Further, the similarity degree of the partial ontology (3) is “0”, and the similarity degree of the partial ontology (4) is “0.2”.

It is assumed that the similarity degree condition (A) is “0.2 or larger”. In this case, partial ontologies that have similarity degrees satisfying the similarity degree condition (A), that are applicable partial ontologies, are the partial ontologies (1), (2), and (4).

Therefore, the candidate extraction unit 212 extracts the applicable partial ontologies (1), (2), and (4) from the cloud-system-oriented ontology 291.

Further, the candidate extraction unit 212 extracts from the cloud-system-oriented ontology 291, partial ontologies for linking the applicable partial ontologies (1), (2), and (4), that are the linking partial ontologies. Partial ontologies corresponding to “mammal”, “bird”, and “animal” which are higher nodes for the applicable partial ontologies (1), (2), and (4) are the linking partial ontologies.

In FIG. 9, the ontology candidate (A) includes the linking partial ontologies and the applicable partial ontologies (1), (2), and (4). The ontology candidate (A) is a smallest part obtained by linking the applicable partial ontologies (1), (2), and (4), in the cloud-system-oriented ontology 291 (see FIG. 7).

Returning to FIG. 4, descriptions will be continued from step S130.

In step S130, the constraint determination unit 213 determines whether or not the ontology candidate (A) satisfies a constraint condition used for the edge system 112A. The constraint condition used for the edge system 112A is referred to as a constraint condition (A).

The constraint condition (A) is a condition regarding the edge-system-oriented ontology 295A, and is indicated in the constraint data 294A.

For example, the constraint condition (A) is a condition regarding size of the edge-system-oriented ontology 295A. The size of the edge-system-oriented ontology 295A can be expressed by depth of the lowest node in the edge-system-oriented ontology 295A and so on. The depth of the lowest node is depth of a level where the lowest node is located.

A specific example of step S130 will be described with reference to FIG. 9.

It is assumed that the constraint condition (A) is that “node depth is four or smaller”. The node depth means the depth of the lowest node. In FIG. 9, the depth of the lowest node “value” in the ontology candidate (A) is “4”. In this case, the ontology candidate (A) satisfies the constraint condition (A).

Returning to FIG. 4, the descriptions of step S130 will be continued.

If the ontology candidate (A) satisfies the constraint condition (A), the process proceeds to step S140.

If the ontology candidate (A) does not satisfy the constraint condition (A), the process proceeds to step S150.

In step S140, the ontology output unit 214 outputs the ontology candidate (A) as the edge-system-oriented ontology 295A.

Specifically, the ontology output unit 214 stores in the storage unit 290, the ontology candidate (A) as the edge-system-oriented ontology 295A. Further, the ontology output unit 214 transmits the edge-system-oriented ontology 295A to the edge system 112A.

After step S140, the process ends.

In step S150, the benchmark data 292A is changed. A method of changing the benchmark data 292A is arbitrary.

For example, an administrator changes the benchmark data 292A, and inputs into the ontology generation apparatus 200, the benchmark data 292A which is after being changed. Then, the similarity degree computation unit 211 accepts the benchmark data 292A which is after being changed, and the storage unit 290 replaces the current benchmark data 292A with the benchmark data 292A which is after being changed.

After step S150, the process proceeds to step S110.

### Description of Examples

The edge system 112 may perform its own information process (for example, a statistical process) by using data collected from each sensor 113.

The cloud-system-oriented ontology 291 is generated based on, for example, each type of data (log data or sensor data) output from the edge system 112, or each type of data output from an application program of the cloud system 111. The cloud-system-oriented ontology 291 may be generated by utilizing a public ontology disclosed in the Internet 101. The public ontology is also called Linked Open Data.

The constraint data 294 is generated, for example, manually. The constraint data 294 may be generated automatically based on an amount of usable resource which is acquired from the edge system 112. The constraint condition may be a condition for accuracy (similarity degree) of an ontology, a memory capacity of the edge system 112, or processing performance of the edge system 112. A threshold value to be the constraint condition may be one of a maximum limit value, a minimum limit value, and a combination of these.

A word which is subject to the similarity degree may be a word other than a word in the relation in the ontology. For example, the word subject to the similarity degree may be a word in the node in the ontology, that is a node name.

### Effect of First Embodiment

By extracting an ontology satisfying the constraint condition used for the edge system 112 from the cloud-system-oriented ontology 291, it is possible to generate the edge-system-oriented ontology 295 that can be used on the resources of the edge system 112.

By adjusting the similarity degree condition and the constraint condition for each edge system 112, it is possible to generate the edge-system-oriented ontology 295 suitable for the edge system 112.

### Second Embodiment

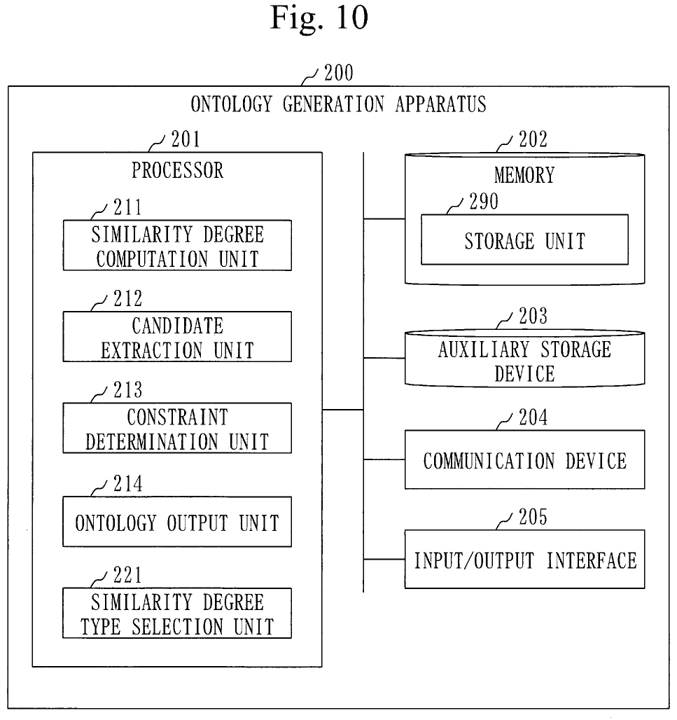

For a mode of computing a suitable similarity degree by a suitable similarity degree computation method selected from among various types of similarity degree computation methods, mainly matters different from the first embodiment will be described with reference to FIG. 10 to FIG. 15.

### Description of Configuration

A configuration of the IoT system 100 is the same as the configuration in the first embodiment (see FIG. 1).

A configuration of the ontology generation apparatus 200 will be described with reference to FIG. 10.

The ontology generation apparatus 200 further includes a similarity degree type selection unit 221.

The ontology generation program further causes a computer to function as the similarity degree type selection unit 221.

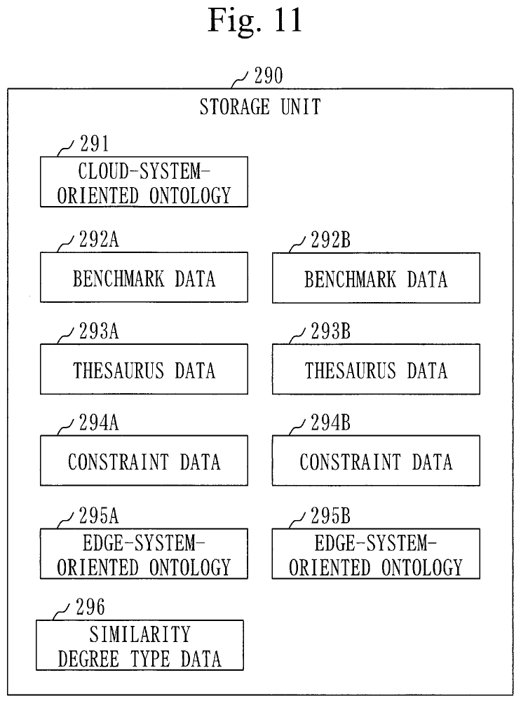

An example of data stored in the storage unit 290 will be described with reference to FIG. 11.

The storage unit 290 further stores similarity degree type data 296 in advance. Details of the similarity degree type data 296 will be described later.

### Description of Operation

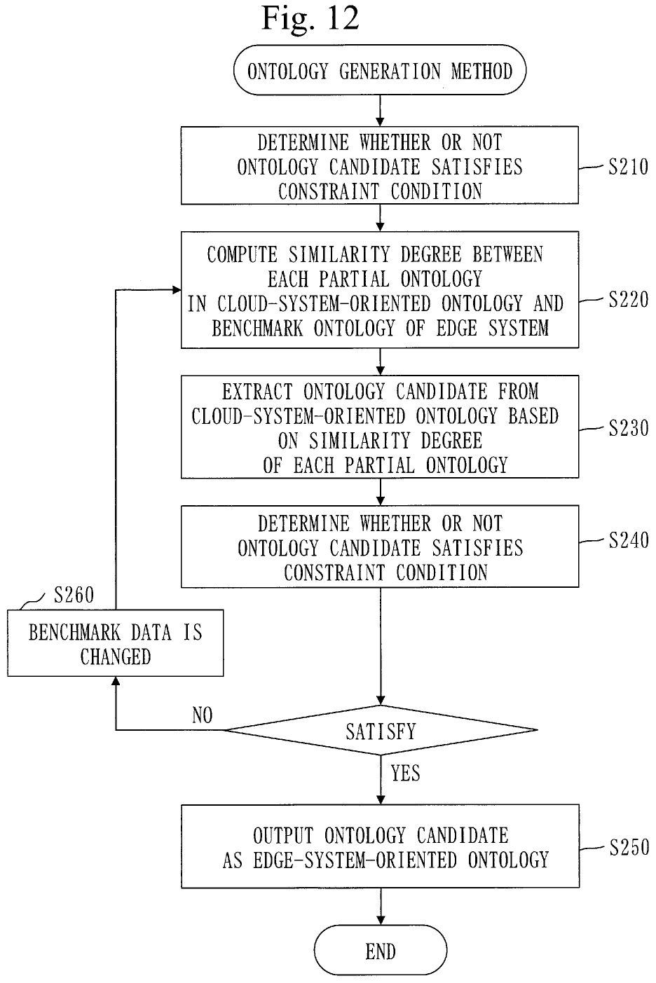

The ontology generation method will be described with reference to FIG. 12.

In step S210, the similarity degree type selection unit 221 selects a similarity degree type corresponding to an operation environment of the edge system 112A.

The similarity degree type is a type of the similarity degree of each partial ontology.

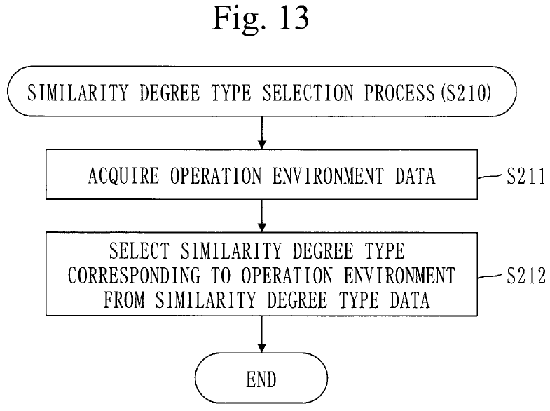

A procedure of a similarity degree type selection process (S210) will be described with reference to FIG. 13.

In step S211, the similarity degree type selection unit 221 acquires operation environment data (A) from the edge system 112A by communicating with the edge system 112A.

The operation environment data (A) indicates the operation environment of the edge system 112A.

The operation environment means an amount of resource such as a memory capacity or processing performance.

The operation environment indicated in the operation environment data (A) is referred to as an operation environment (A).

In step S212, the similarity degree type selection unit 221 selects from the similarity degree type data 296, the similarity degree type corresponding to the operation environment (A).

For example, the similarity degree type selection unit 221 selects the similarity degree type corresponding to the processing performance of the edge system 112A.

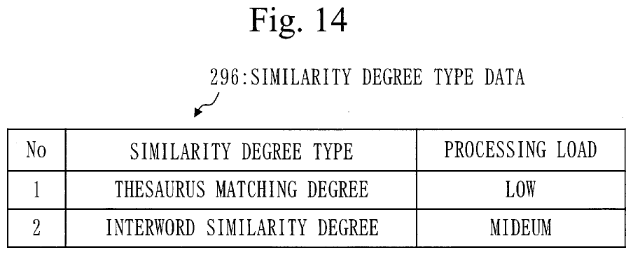

A specific example of step S212 will be described with reference to FIG. 14.

FIG. 14 illustrates a specific example of the similarity degree type data 296.

The similarity degree type data 296 indicates a plurality of similarity degree types. Each similarity degree type is associated with processing-load information. The processing-load information indicates a processing load required for using the edge-system-oriented ontology 295 generated based on the corresponding similarity degree type.

It is assumed that the operation environment data (A) indicates the operation environment (A) where the processing performance of the edge system 112A is low. In this case, the similarity degree type selection unit 221 selects a processing load “low” from the similarity degree type data 296. Then, the similarity degree type selection unit 221 selects from the similarity degree type data 296, a similarity degree type “thesaurus matching degree” associated with the selected processing load “low”.

The similarity degree type “thesaurus matching degree” means a matching degree between a thesaurus for a word in the benchmark ontology (A) and a thesaurus for a word in the partial ontology.

A similarity degree type “interword similarity degree” means the similarity degree described in the first embodiment.

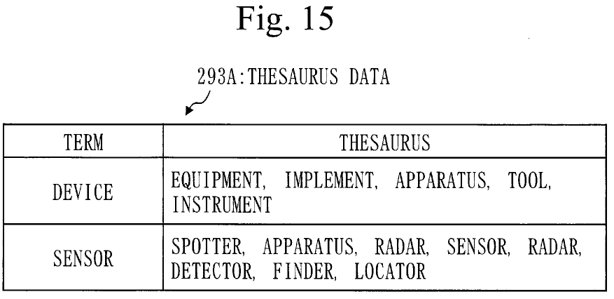

A specific example of the thesaurus matching degree will be described with reference to FIG. 15.

FIG. 15 illustrates a specific example of the thesaurus data 293A.

The thesaurus data 293A indicates a thesaurus for each type of term.

It is assumed that the word in the benchmark ontology (A) is “device”, and the word in the partial ontology is “sensor”. A common word “apparatus” is included in both the thesaurus for the word “device” and the thesaurus for the word “sensor”. In this case, the similarity degree of the partial ontology is “1”. If the common word “apparatus” is not included in both the thesaurus for the word “device” and the thesaurus for the word “sensor”, the similarity degree of the partial ontology is “0”.

Calculation of the thesaurus matching degree is simpler compared to calculation of the interword similarity degree. When the similarity degree type “thesaurus matching degree” is selected, there is concern that accuracy of the similarity degree computed by the similarity degree computation unit 211 is deteriorated, but it is possible to perform the process of the similarity degree computation unit 211 at high speed.

Returning to FIG. 12, processes after step S210 will be described.

Step S220 to step S260 are the same as step S110 to step S150 in the first embodiment.

However, in step S220, the similarity degree computation unit 211 computes the similarity degree of each partial ontology by a computation process for the similarity degree type selected in step S210.

The computation process for each similarity degree type is defined in advance in a format such as a calculation equation, a function, or a program.

### Effect of Second Embodiment

It is possible to compute a suitable type of similarity degree according to the operation environment of the edge system 112. As a result, a suitable edge-system-oriented ontology 295 according to the operation environment of the edge system is generated. Further, it is possible to adjust trade-off between the accuracy of the similarity degree and the calculation load of the similarity degree.

### Third Embodiment

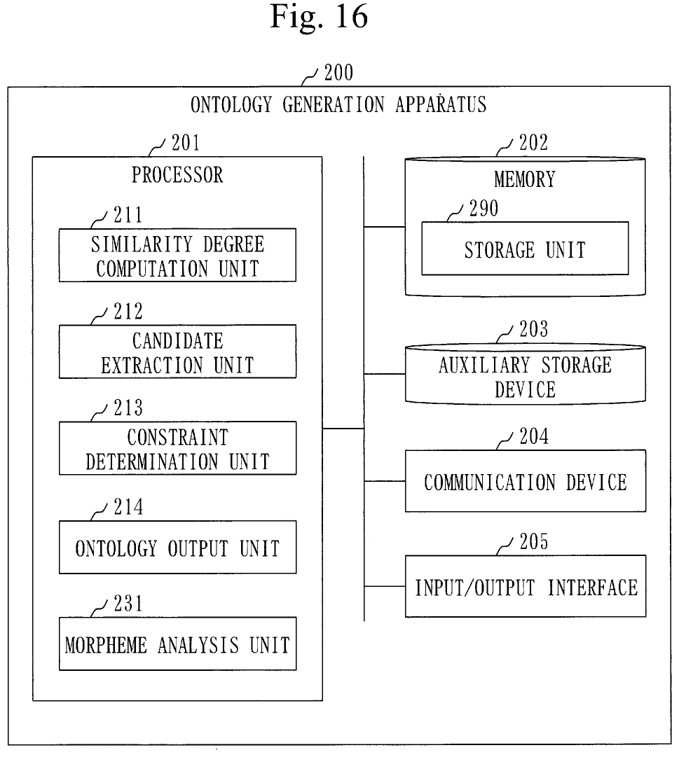

For a mode of computing the similarity degree of the partial ontology by taking into account, a plurality of nodes in the partial ontology and a relation between the plurality of nodes, mainly matters different from the first embodiment will be described with reference to FIGS. 16 to 19.

### Description of Configuration

A configuration of the IoT system 100 is the same as the configuration in the first embodiment (see FIG. 1).

A configuration of the ontology generation apparatus 200 will be described with reference to FIG. 16.

The ontology generation apparatus 200 further includes a morpheme analysis unit 231.

The ontology generation program further causes a computer to function as the morpheme analysis unit 231.

### Description of Operation

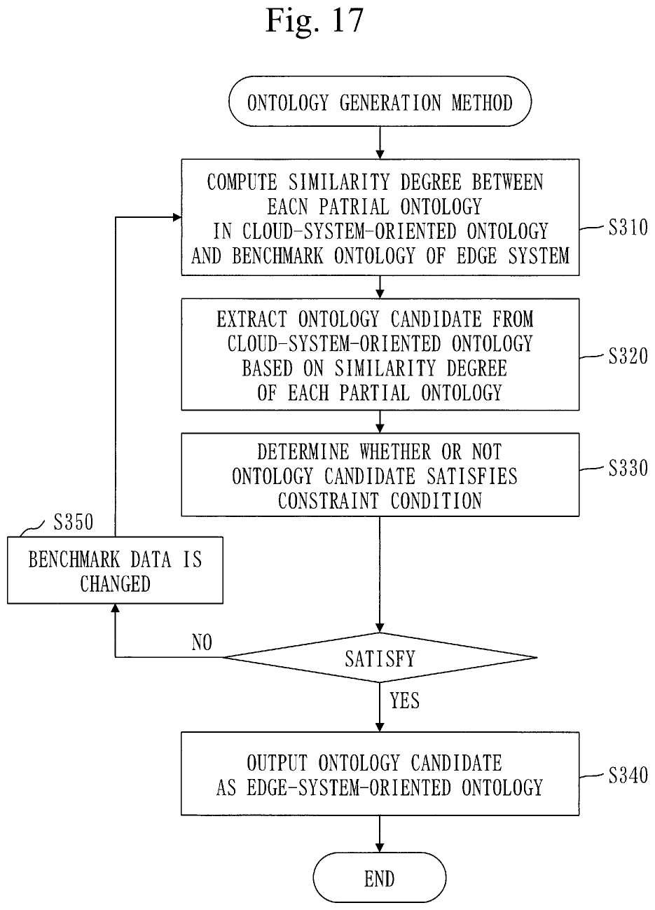

The ontology generation method will be described with reference to FIG. 17.

In step S310, the similarity degree computation unit 211 computes the similarity degree between each partial ontology in the cloud-system-oriented ontology 291 and the benchmark ontology of the edge system 112A. That is, the similarity degree computation unit 211 computes the similarity degree of each partial ontology.

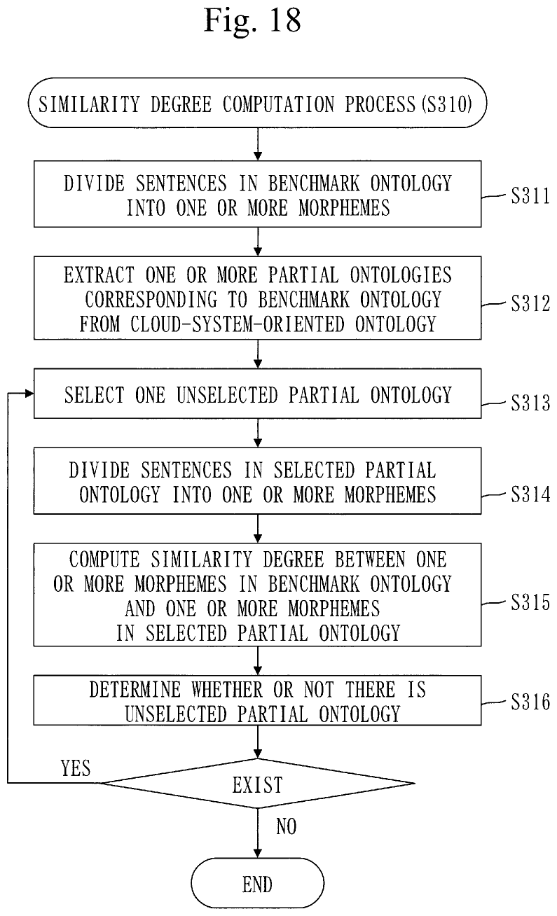

A procedure of a similarity degree computation process (S310) will be described with reference to FIG. 18.

In step S311, the morpheme analysis unit 231 divides a sentence in the benchmark ontology (A) into one or more morphemes. The morpheme corresponds to a word.

Specifically, the sentences to be divided are a node name of each of a plurality of nodes included in the benchmark ontology (A), and relation information indicating a relation between the plurality of nodes.

In the benchmark ontology (A) in FIG. 6, each of a node name “animal”, a node name “value”, and relation information “attribute-of age” corresponds to the sentence to be divided.

One morpheme “animal” is obtained from a node name “animal”. One morpheme “value” is obtained from a node name “value”. The relation information “attribute-of age” is divided into three morphemes “attribute”, “of”, and “age”.

In step S312, the similarity degree computation unit 211 extracts one or more partial ontologies corresponding to the benchmark ontology (A) from the cloud-system-oriented ontology 291.

An extraction method is the same as the method in step S111 in the first embodiment. However, a type of the relation in each partial ontology to be extracted does not need to match a type of the relation in the benchmark ontology (A). For example, when the relation in the benchmark ontology (A) is an attribution relation “attribute-of”, it is acceptable if a partial ontology regarding an inclusion relation “part-of” is extracted.

In step S313, the similarity degree computation unit 211 selects one unselected partial ontology from the one or more partial ontologies extracted in step S312.

In step S314, the morpheme analysis unit 231 divides sentences in the selected partial ontology into one or more morphemes.

A division method is the same as the method in step S311.

In step S315, the similarity degree computation unit 211 computes the similarity degree between the one or more morphemes in the benchmark ontology (A) and the one or more morphemes in the selected partial ontology. The similarity degree to be computed is the similarity degree of the selected partial ontology.

Specifically, the similarity degree computation unit 211 computes the similarity degree for each morpheme in the selected partial ontology, and computes a total of the computed similarity degrees. The total to be computed is the similarity degree of the selected partial ontology.

The similarity degree of the selected partial ontology can be expressed by an equation (1).

“Wᵢ” is weight assigned to an i-th morpheme in a node name, and indicates an importance degree of the i-th morpheme in the node name. The weight Wᵢ is a value of zero or larger. Specifically, the weight is different depending on a part of speech of the morpheme. For example, weight of a noun “attribute” is “1”, and weight of a preposition “of” is “0.5”. Since the weight of the preposition is smaller than the weight of the noun, there is less effect by noise of the preposition.

“Nᵢ” is the i-th morpheme in the node name.

“I” is the number of morphemes in the node name.

“Wⱼ” is weight assigned to a j-th morpheme in relation information, and indicates an importance degree of the j-th morpheme in the relation information. The weight Wⱼ is a value of zero or larger.

“Nⱼ” is the j-th morpheme in the relation information.

“J” is the number of morphemes in the relation information.

“f(x)” is a function for computing the similarity degree of the morpheme x. In the function f(x), the morpheme x is treated as a word. Then, by the function f(x), the interword similarity degree is computed as the similarity degree of the morpheme x. A computation method of the interword similarity degree is as described in the first embodiment. However, by the function f(x), the thesaurus matching degree may be computed as the similarity degree of the morpheme x. The computation method of the thesaurus matching degree is as described in the second embodiment.

$$Similarity Degree = {\sum }_{i = 1}^{I} {W}_{i} f ( {N}_{i} ) + {\sum }_{j = 1}^{J} {W}_{j} f ( {M}_{j} ) \qquad [ Equation 1 ]$$

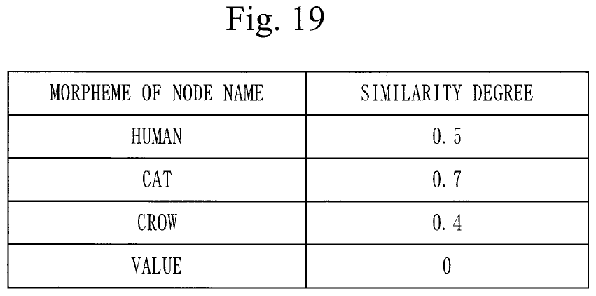

A specific example of the similarity degree of each partial ontology will be described with reference to FIG. 19.

FIG. 19 illustrates the similarity degree of each morpheme in the node name. The similarity degree of a morpheme “human” is “0.5”. The similarity degree of a morpheme “cat” is “0.7”. The similarity degree of a morpheme “crow” is “0.4”. The similarity degree of a morpheme “value” is “0”.

In FIG. 7, it is assumed that the similarity degree of the relation information “attribute-of age” in the partial ontology (1) is “1.0”. In this case, the similarity degree of the partial ontology (1) is “1.5 (=1.0+0.5+0)”.

In FIG. 7, it is assumed that the similarity degree of the relation information “attribute-of age” in the partial ontology (2) is “1.0”. In this case, the similarity degree of the partial ontology (2) is “1.7(=1.0+0.7+0)”.

In FIG. 7, it is assumed that the similarity degree of the relation information “attribute-of years” in the partial ontology (4) is “0.2”. In this case, the similarity degree of the partial ontology (4) is “0.6 (=0.2+0.4+0)”.

Returning to FIG. 18, step S316 will be described.

In step S316, the similarity degree computation unit 211 determines whether or not there is an unselected partial ontology among the one or more partial ontologies extracted in step S312.

If there is the unselected partial ontology, the process proceeds to step S313. If there is no unselected partial ontology, the process ends.

### Description of Examples

The second embodiment may be applied to the third embodiment. That is, the ontology generation apparatus 200 may include the similarity degree type selection unit 221. The similarity degree computation unit 211 computes the similarity degree which is a type selected by the similarity degree type selection unit 221.

### Effect of Third Embodiment

It is possible to compute the similarity degree by seeing the node name and the relation information from a higher perspective. Further, it is possible to compute the similarity degree even if the node name or the relation information is a sentence. Consequently, accuracy of extracting the ontology candidate is improved. As a result, more suitable edge-system-oriented ontology 295 is generated.

### Fourth Embodiment

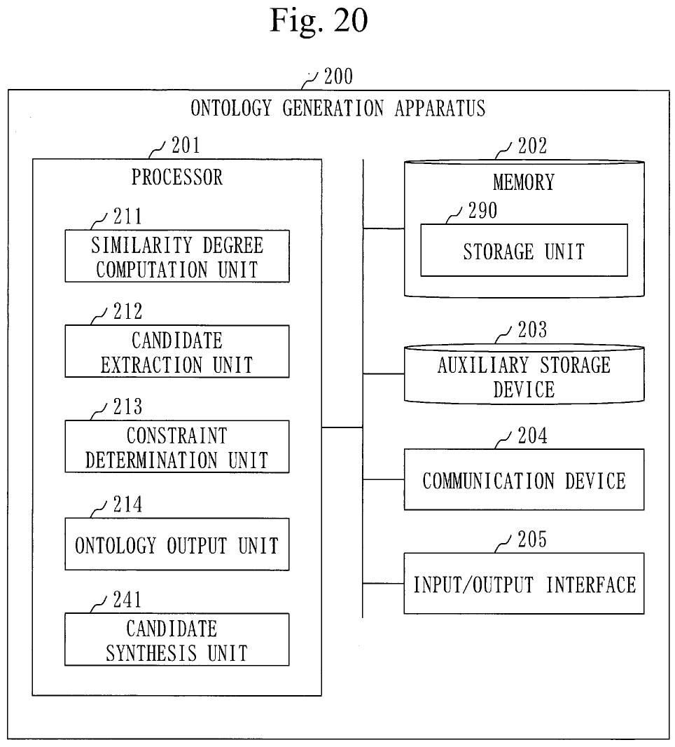

For a mode of generating the edge-system-oriented ontology 295 by using a plurality of benchmark ontologies, mainly matters different from the first embodiment will be described with reference to FIGS. 20 to 26.

### Description of Configuration

A configuration of the IoT system 100 is the same as the configuration in the first embodiment (see FIG. 1).

A configuration of the ontology generation apparatus 200 will be described with reference to FIG. 20.

The ontology generation apparatus 200 further includes a candidate synthesis unit 241.

The ontology generation program further causes a computer to function as the candidate synthesis unit 241.

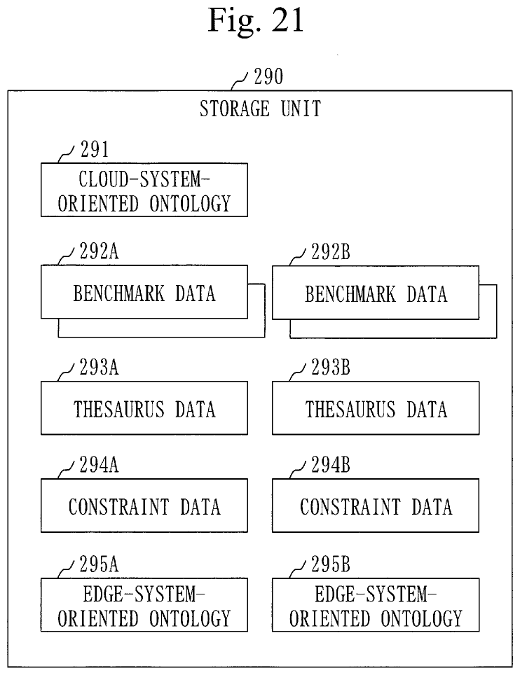

An example of data to be stored in the storage unit 290 will be described with reference to FIG. 21.

The storage unit 290 stores a plurality of pieces of benchmark data 292A and a plurality of pieces of benchmark data 292B in advance.

### Description of Operation

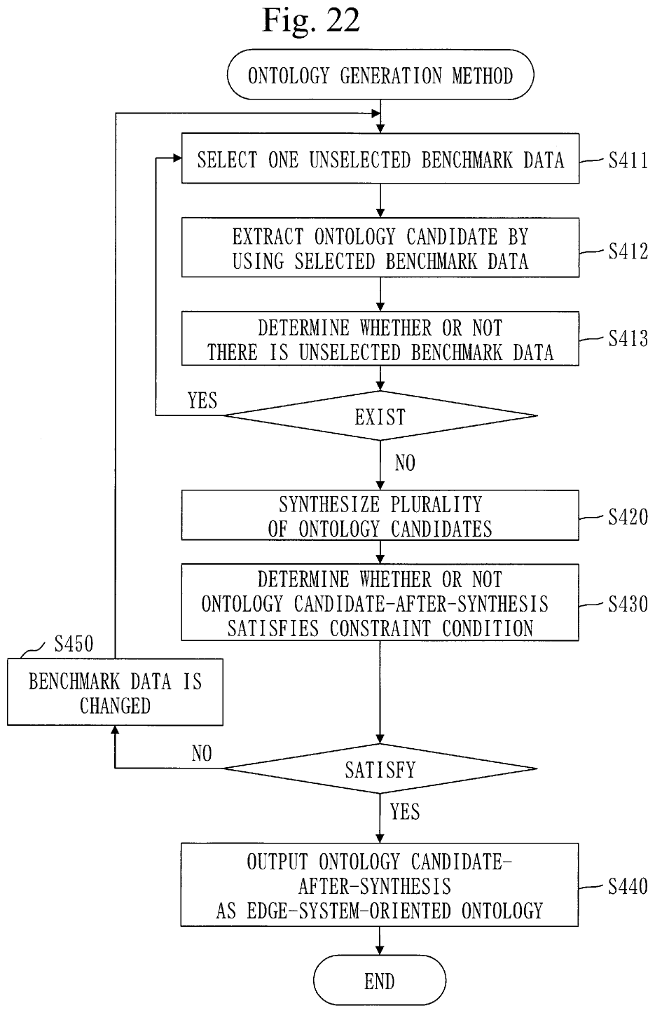

The ontology generation method will be described with reference to FIG. 22.

In step S411, the similarity degree computation unit 211 selects one unselected benchmark data 292A.

In step S412, the similarity degree computation unit 211 computes the similarity degree of each partial ontology by using the selected benchmark data 292A. The computation method is the same as the method in step S110 in the first embodiment.

Then, the candidate extraction unit 212 extracts the ontology candidate (A) based on the computed similarity degree of each partial ontology. An extraction method is the same as the method in step S120 in the first embodiment.

In step S413, the similarity degree computation unit 211 determines whether or not there is the unselected benchmark data 292A.

If there is the unselected benchmark data 292A, the process proceeds to step S411.

If there is no unselected benchmark data 292A, the process proceeds to step S420.

Through the processes from step S411 to step S413, the plurality of ontology candidates (A) corresponding to the plurality of pieces of benchmark data 292A are obtained.

In step S420, the candidate synthesis unit 241 synthesizes the plurality of ontology candidates (A). The ontology obtained by the synthesis is referred to as an ontology candidate-after-synthesis.

In other words, the candidate synthesis unit 241 generates by linking the plurality of ontology candidates (A), the ontology candidate-after-synthesis. A method of generating the ontology candidate-after-synthesis is the same as the method of generating the ontology candidate (A) by linking the plurality of partial ontologies (see step S120 in the first embodiment).

In step S430, the constraint determination unit 213 determines whether or not the ontology candidate-after-synthesis satisfies the constraint condition (A). A determination method is the same as the method in step S130 in the first embodiment. If the ontology candidate-after-synthesis satisfies the constraint condition (A), the process proceeds to step S440.

If the ontology candidate-after-synthesis does not satisfy the constraint condition (A), the process proceeds to step S450.

In step S440, the ontology output unit 214 outputs the ontology candidate-after-synthesis as the edge-system-oriented ontology 295A. An output method is the same as the method in step S140 in the first embodiment.

In step S450, at least one of the plurality of pieces of benchmark data 292A is changed. A change method is the same as the method in step S150 in the first embodiment.

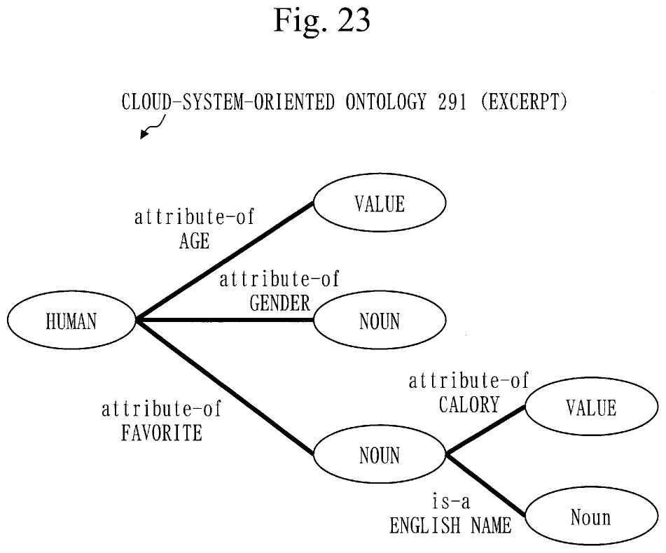

A specific example of step S420 will be described with reference to FIGS. 23 to 26.

FIG. 23 illustrates a part of a specific example of the cloud-system-oriented ontology 291.

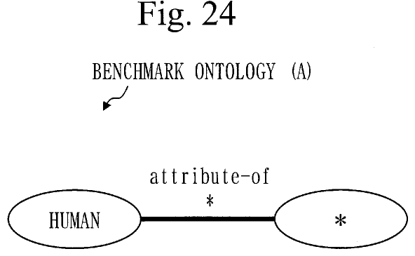

FIG. 24 illustrates a specific example of the benchmark ontology (A) indicated in the benchmark data 292A. An asterisk in the benchmark ontology (A) means a string of arbitrary characters.

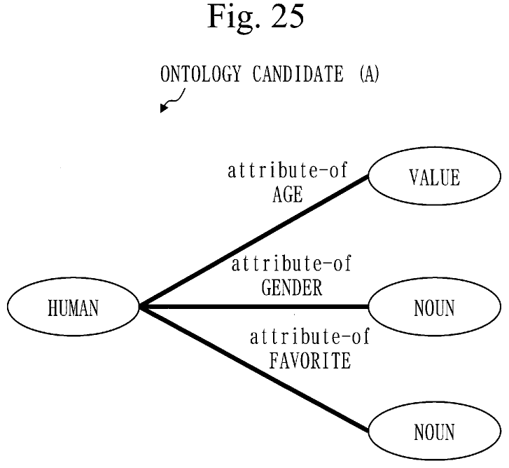

FIG. 25 illustrates a specific example of the ontology candidate (A).

The ontology candidate (A) in FIG. 25 is extracted from the cloud-system-oriented ontology 291 in FIG. 23 based on the benchmark ontology (A) in FIG. 24.

It is assumed that the ontology candidate (A) in FIG. 9 is extracted based on another benchmark ontology (A) than the benchmark ontology (A) in FIG. 24.

A “human” node is common in the ontology candidate (A) in FIG. 9 and the ontology candidate (A) in FIG. 25.

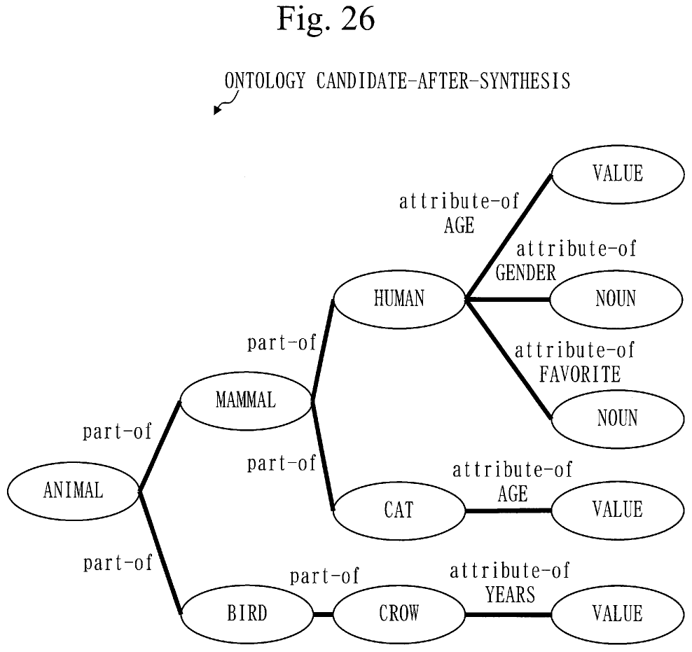

In this case, the candidate synthesis unit 241 synthesizes the ontology candidate (A) in FIG. 9 and the ontology candidate (A) in FIG. 25 by setting the “human” node as a connection point. Consequently, the ontology candidate-after-synthesis in FIG. 26 is obtained.

If there is no common node in the two ontology candidates (A), the candidate synthesis unit 241 may synthesize the two ontology candidates (A) by setting as a common node (connection point), two nodes which are the most similar to each other in the two ontology candidates (A).

### Description of Examples

The second embodiment may be applied to the fourth embodiment. That is, the ontology generation apparatus 200 may include the similarity degree type selection unit 221. The similarity degree computation unit 211 computes the similarity degree which is a type selected by the similarity degree type selection unit 221.

The third embodiment may be applied to the fourth embodiment. That is, the ontology generation apparatus 200 may include the morpheme analysis unit 231. The similarity degree computation unit 211 computes the similarity degree based on one or more morphemes obtained by the morpheme analysis unit 231.

### Effect of Fourth Embodiment

By synthesizing the plurality of ontology candidates corresponding to the plurality of benchmark ontologies, it is possible to obtain an ontology (the ontology candidate-after-synthesis) having a lot of knowledge which is deeply relevant to the edge system 112. As a result, inference accuracy by the edge-system-oriented ontology 295 is improved.

### Fifth Embodiment

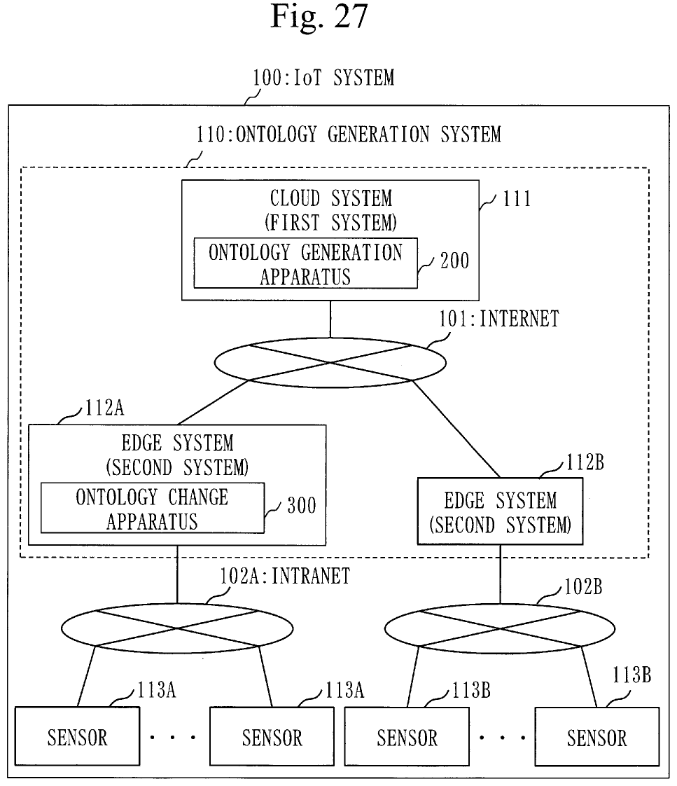

For a mode of reducing the edge-system-oriented ontology 295, mainly matters different from the first to fourth embodiments will be described with reference to FIGS. 27 to 32.

### Description of Configuration

A configuration of the IoT system 100 will be described with reference to FIG. 27.

In the IoT system 100, the ontology generation system 110 is realized by the cloud system 111 and each edge system (112A and 112B).

The edge system 112A includes an ontology change apparatus 300. Further, the edge system 112B includes an apparatus (not illustrated) equivalent to the ontology change apparatus 300.

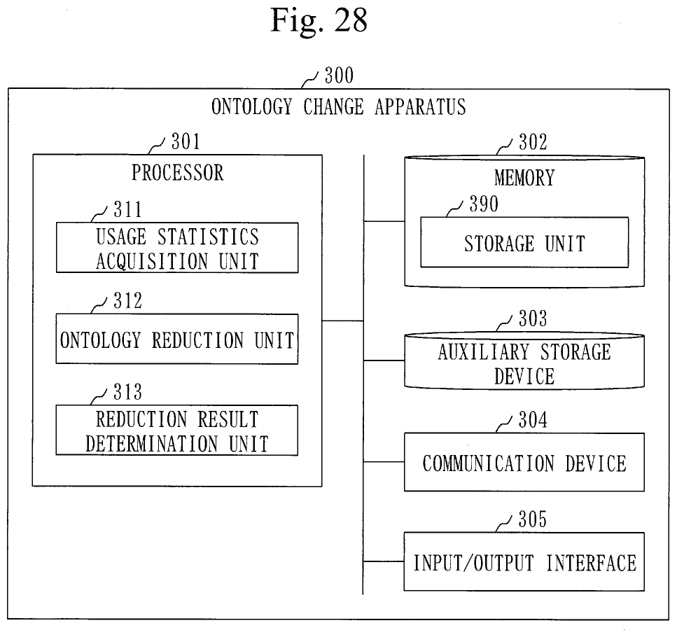

A configuration of the ontology change apparatus 300 will be described with reference to FIG. 28.

The ontology change apparatus 300 is a computer which includes pieces of hardware such as a processor 301, a memory 302, an auxiliary storage device 303, a communication device 304, and an input/output interface 305. These pieces of hardware are connected with each other via signal lines.

The processor 301 is an IC, which performs a calculation process, and controls the other pieces of hardware. For example, the processor 201 is a CPU, a DSP, or a GPU.

The memory 302 is a volatile storage device. The memory 302 is also called a main storage device or a main memory. For example, the memory 302 is a RAM. Data stored in the memory 302 is stored in the auxiliary storage device 303 as necessary.

The auxiliary storage device 303 is a non-volatile storage device. For example, the auxiliary storage device 303 is a ROM, an HDD, or a flash memory. Data stored in the auxiliary storage device 303 is loaded into the memory 302 as necessary.

The communication device 304 is a receiver and a transmitter. For example, the communication device 304 is a communication chip or an NIC.

The input/output interface 305 is a port to which an input device and an output device are connected. For example, the input/output interface 305 is a USB terminal, the input devices are a keyboard and a mouse, and the output device is a display.

The ontology change apparatus 300 includes elements such as a usage statistics acquisition unit 311, an ontology reduction unit 312, and a reduction result determination unit 313. These elements are realized by software.

The auxiliary storage device 303 stores an ontology change program for causing a computer to function as the usage statistics acquisition unit 311, the ontology reduction unit 312, and the reduction result determination unit 313. The ontology change program is loaded into the memory 302, and executed by the processor 301.

The auxiliary storage device 303 further stores an OS. At least a part of the OS is loaded into the memory 302, and executed by the processor 301.

The processor 301 executes the ontology change program while executing the OS.

Input/output data of the ontology change program is stored in a storage unit 390.

The memory 302 functions as the storage unit 390. However, storage devices such as the auxiliary storage device 303, a register in the processor 301, and a cash memory in the processor 301 may function as the storage unit 390 instead of the memory 302 or together with the memory 302.

The ontology change apparatus 300 may include a plurality of processors which substitute for the processor 301. The plurality of processors share a role of the processor 301.

The ontology change program can be recorded (stored) in a non-volatile recording medium such as an optical disk or a flash memory in a computer-readable manner.

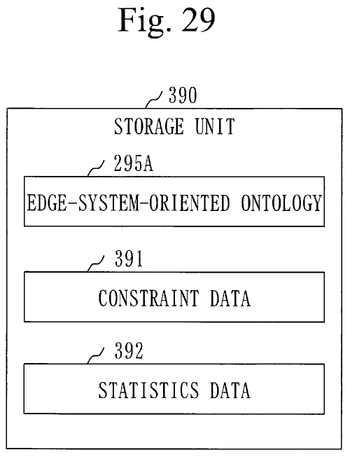

An example of data stored in the storage unit 390 will be described with reference to FIG. 29.

The storage unit 390 stores the edge-system-oriented ontology 295A generated by the ontology generation apparatus 200. The edge-system-oriented ontology 295A is used in the edge system 112A.

The storage unit 390 stores constraint data 391 in advance. Details of the constraint data 391 will be described later.

The storage unit 390 stores statistics data 392. Details of the statistics data 392 will be described later.

### Description of Operation

A procedure of operation of the ontology change apparatus 300 corresponds to an ontology change method. The ontology change method is a part of the ontology generation method.

The procedure of the operation of the ontology change apparatus 300 corresponds to a procedure of a process by the ontology change program. The ontology change program is a part of the ontology generation program.

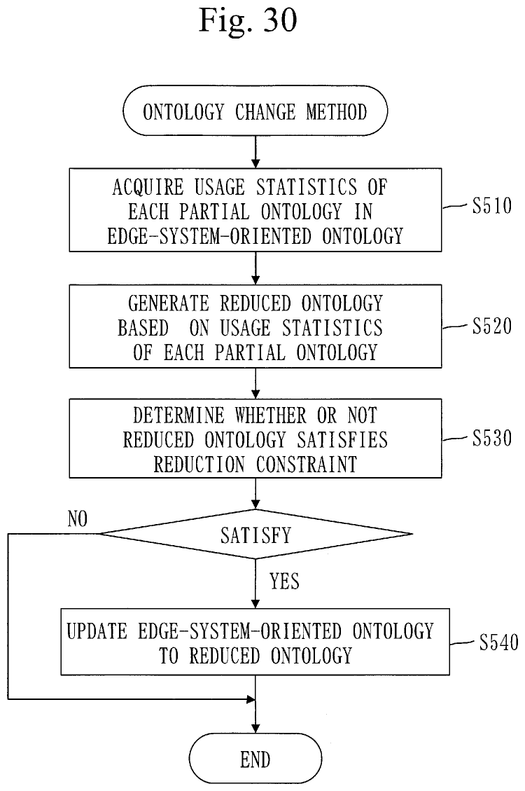

The ontology change method will be described with reference to FIG. 30.

In step S510, the usage statistics acquisition unit 311 acquires usage statistics of each partial ontology in the edge-system-oriented ontology 295A. An acquisition method is arbitrary.

The usage statistics of the partial ontology is statistics information regarding usage of the partial ontology. Specifically, the usage statistics of the partial ontology is a usage frequency of the partial ontology. The usage statistics of the partial ontology may be statistics information obtained by aggregating or editing the usage frequency of the partial ontology or the like.

The usage statistics acquisition unit 311 stores in the storage unit 390, data indicating the acquired usage statistics of each partial ontology. The data to be stored is the statistics data 392.

In step S520, the ontology reduction unit 312 generates a reduced ontology (A) based on the usage statistics of each partial ontology indicated in the statistics data 392.

The reduced ontology (A) is an ontology obtained by deleting one or more partial ontologies from the edge-system-oriented ontology 295A.

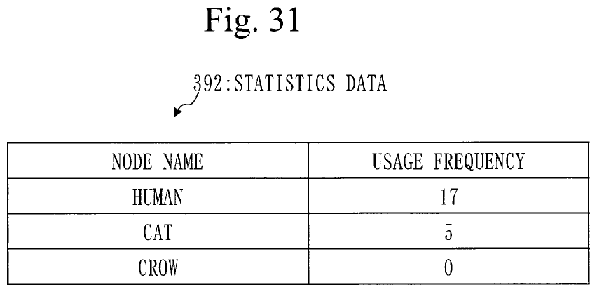

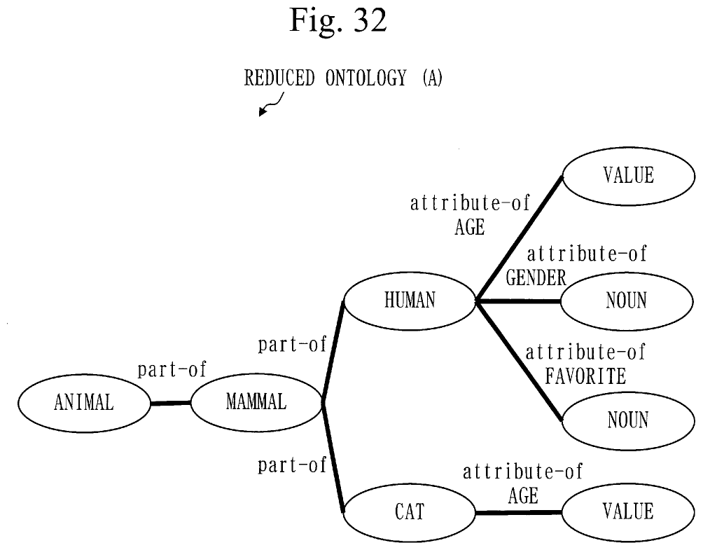

A specific example of step S520 will be described with reference to FIGS. 31 and 32.

In FIG. 31, the statistics data 392 indicates the usage frequency of each node. The usage frequency of each node corresponds to the usage frequency of the partial ontology having each node.

It is assumed that a frequency threshold value compared to the usage frequency of each node is “0”. A usage frequency “17” of a “human” node is larger than the frequency threshold value “0”. A usage frequency “5” of a “cat” node is larger than the frequency threshold value “0”. A usage frequency “0” of a “crow” node is the frequency threshold value “0” or smaller. The “crow” node whose usage frequency is “0” is an unnecessary node.

In this case, the ontology reduction unit 312 generates the reduced ontology (A) as illustrated in FIG. 32 by deleting a partial ontology having the “crow” node. In the reduced ontology (A), there are still the partial ontology having the “human” node and the partial ontology having the “cat” node, but there is no partial ontology having the “crow” node.

Returning to FIG. 30, descriptions will be continued from step S530.

In step S530, the reduction result determination unit 313 determines whether or not the reduced ontology (A) satisfies a reduction constraint (A).

The reduction constraint (A) is a condition regarding the reduced ontology (A), and is indicated in the statistics data 392.

For example, the reduction constraint (A) is a condition regarding size of the reduced ontology (A), and indicates a size threshold value.

In this case, the reduction result determination unit 313 computes the size of the reduced ontology (A), and compares the size of the reduced ontology (A) to the size threshold value.

When the size of the reduced ontology (A) is the size threshold value or larger, the reduced ontology (A) is not reduced excessively, and the reduced ontology (A) satisfies the reduction constraint (A).

When the size of the reduced ontology (A) is smaller than the size threshold value, the reduced ontology (A) is reduced excessively, and the reduced ontology (A) does not satisfy the reduction constraint (A).

When the reduced ontology (A) satisfies the reduction constraint (A), the process proceeds to step S540.

When the reduced ontology (A) does not satisfy the reduction constraint (A), the process ends.

In step S540, the ontology reduction unit 312 updates to the reduced ontology (A), the edge-system-oriented ontology 295A stored in the storage unit 390.

After step S540, the process ends, and the edge-system-oriented ontology 295A after the update is used in the edge system 112A.

### Description of Examples

The ontology change method may be implemented in the cloud system 111. For example, the ontology generation apparatus 200 may include the usage statistics acquisition unit 311, the ontology reduction unit 312, and the reduction result determination unit 313, and implement the ontology change method.

### Effect of Fifth Embodiment

It is possible to delete the unnecessary partial ontology from the edge-system-oriented ontology 295 based on the usage statistics of each partial ontology. Consequently, noise included in the edge-system-oriented ontology 295 is decreased.

### Sixth Embodiment

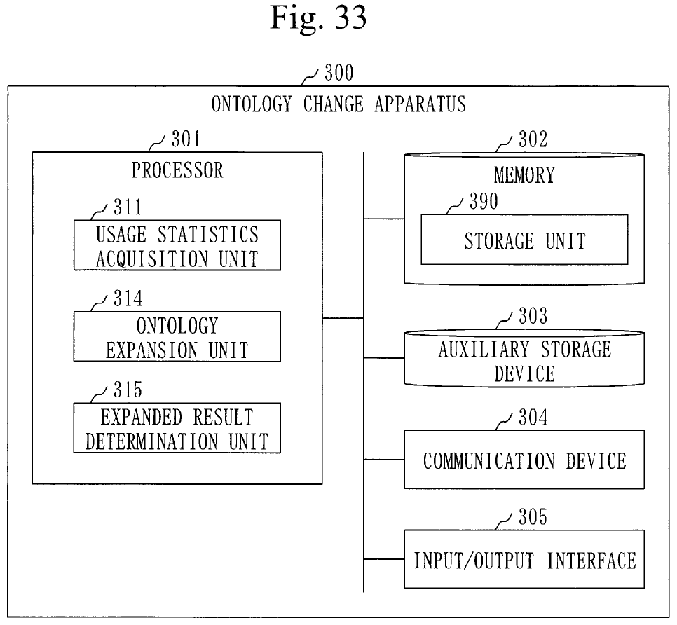

For a mode of expanding the edge-system-oriented ontology 295, mainly matters different from the fifth embodiment will be described with reference to FIGS. 33 to 35.

### Description of Configuration

A configuration of the IoT system 100 is the same as the configuration in the sixth embodiment (see FIG. 27).

A configuration of the ontology change apparatus 300 will be described with reference to FIG. 33.

The ontology change apparatus 300 includes an ontology expansion unit 314 instead of the ontology reduction unit 312, and includes an expansion result determination unit 315 instead of the reduction result determination unit 313.

The ontology change program causes a computer to function as the usage statistics acquisition unit 311, the ontology expansion unit 314, and the expansion result determination unit 315.

### Description of Operation

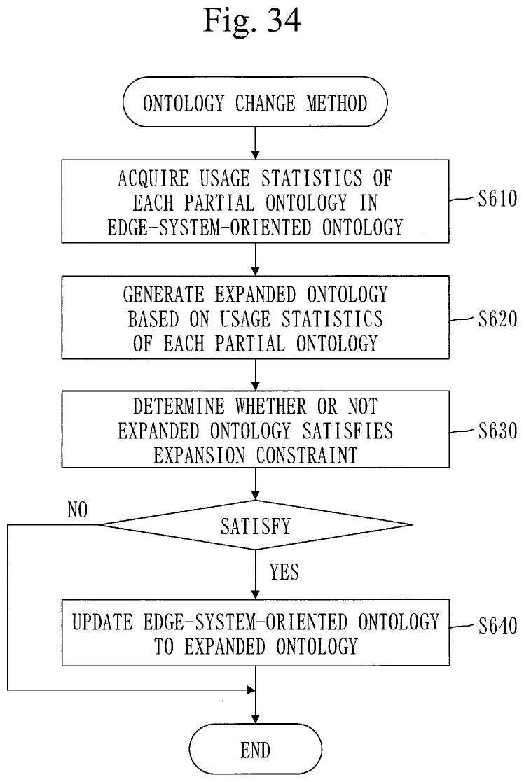

The ontology change method will be described with reference to FIG. 34.

In step S610, the usage statistics acquisition unit 311 acquires the usage statistics of each partial ontology in the edge-system-oriented ontology 295A. An acquisition method is arbitrary.

Step S610 is the same as step S510 in the fifth embodiment.

In step S620, the ontology expansion unit 314 generates an expanded ontology (A) based on the usage statistics of each partial ontology indicated in the statistics data 392.

The expanded ontology (A) is an ontology obtained by adding one or more partial ontologies to the edge-system-oriented ontology 295A.

The ontology expansion unit 314 generates the expanded ontology (A) as follows.

First, the ontology expansion unit 314 acquires the cloud-system-oriented ontology 291 from the cloud system 111 by communicating with the cloud system 111.

Next, the ontology expansion unit 314 extracts one or more partial ontologies from the cloud-system-oriented ontology 291 based on the usage statistics of each partial ontology which is indicated in the statistics data 392. Specifically, the ontology expansion unit 314 selects one or more partial ontologies from the edge-system-oriented ontology 295, and extracts one or more partial ontologies related to the one or more partial ontologies selected, from the cloud-system-oriented ontology 291.

Then, the ontology expansion unit 314 adds to the edge-system-oriented ontology 295, the one or more partial ontologies extracted.

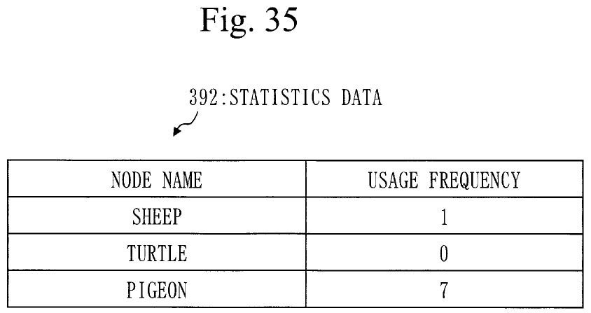

A specific example of the partial ontology extracted from the cloud-system-oriented ontology will be described with reference to FIG. 35.

FIG. 35 illustrates a specific example of the statistics data 392. In the statistics data 392, a node with the highest usage frequency is a “pigeon” node. In this case, the ontology expansion unit 314 extracts from the cloud-system-oriented ontology 291, one or more partial ontologies related to the partial ontology having the “pigeon” node.

Specifically, the ontology expansion unit 314 extracts the partial ontology corresponding to a pair of a “bird” node and the “pigeon” node. The “bird” node is a higher node for the “pigeon” node. The ontology expansion unit 314 may extract the partial ontology having a node whose similarity degree for the “bird” node is high.

Returning to FIG. 34, descriptions will be continued from step S630.

In step S630, the expansion result determination unit 315 determines whether or not the expanded ontology (A) satisfies an expansion constraint (A).

The expansion constraint (A) is a condition regarding the expanded ontology (A), and is indicated in the statistics data 392.

For example, the expansion constraint (A) is a condition regarding size of the expanded ontology (A), and indicates a size threshold value.

In this case, the expansion result determination unit 315 computes the size of the expanded ontology (A), and compares the size of the expanded ontology (A) to the size threshold value.

When the size of the expanded ontology (A) is the size threshold value or smaller, the expanded ontology (A) is not expanded excessively, and the expanded ontology (A) satisfies the expansion constraint (A).

When the size of the expanded ontology (A) is larger than the size threshold value, the expanded ontology (A) is expanded excessively, and the expanded ontology (A) does not satisfy the expansion constraint (A).

When the expanded ontology (A) satisfies the expanded constraint (A), the process proceeds to step S640.

When the expanded ontology (A) does not satisfy the expansion constraint (A), the process ends.

In step S640, the ontology expansion unit 314 updates to the expanded ontology (A), the edge-system-oriented ontology 295A stored in the storage unit 390. After step S640, the process ends, and the edge-system-oriented ontology 295A after the update is used in the edge system 112A.

### Description of Examples

The ontology change method may be implemented in the cloud system 111. For example, the ontology generation apparatus 200 may include the usage statistics acquisition unit 311, the ontology expansion unit 314, and the expansion result determination unit 315, and implement the ontology change method.

The fifth embodiment may be applied to the sixth embodiment. That is, the ontology change apparatus 300 may include the ontology expansion unit 314 and the expansion result determination unit 315.

### Effect of Sixth Embodiment

It is possible to add based on the usage statistics of each partial ontology, a partial ontology with high necessity to the edge-system-oriented ontology 295. Consequently, it is possible to obtain more suitable edge-system-oriented ontology 295.

### Supplement to Embodiments

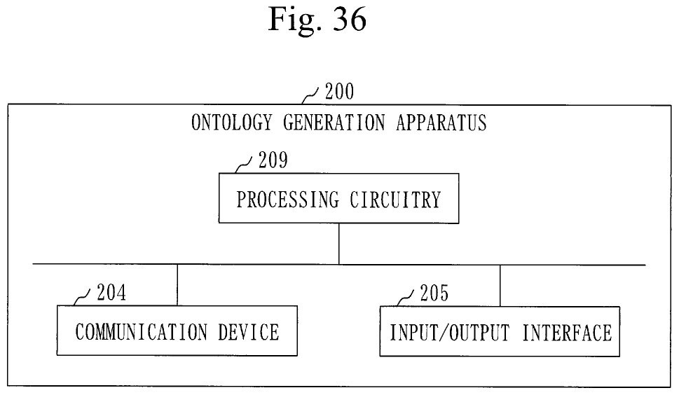

A hardware configuration of the ontology generation apparatus 200 will be described with reference to FIG. 36.

The ontology generation apparatus 200 includes a processing circuitry 209.

The processing circuitry 209 is hardware that realizes the similarity degree computation unit 211, the candidate extraction unit 212, the constraint determination unit 213, the ontology output unit 214, the similarity degree type selection unit 221, the morpheme analysis unit 231, and the candidate synthesis unit 241.

The processing circuitry 209 may be dedicated hardware, or maybe the processor 201 that executes a program stored in the memory 202.

When the processing circuitry 209 is the dedicated hardware, the processing circuitry 209 is, for example, a single circuit, a composite circuit, a programmed processor, a parallel-programmed processor, an ASIC, an FPGA, or a combination of these.

ASIC stands for Application Specific Integrated Circuit.

FPGA stands for Field Programmable Gate Array.

The ontology generation apparatus 200 may include a plurality of processing circuitries that substitute for the processing circuitry 209. The plurality of processing circuitries share a roll of the processing circuitry 209.

In the ontology generation apparatus 200, a part of a function may be realized by the dedicated hardware, and the remaining function may be realized by software or firmware.

As described above, the processing circuitry 209 can be realized by the hardware, the software, the firmware, or a combination of these.

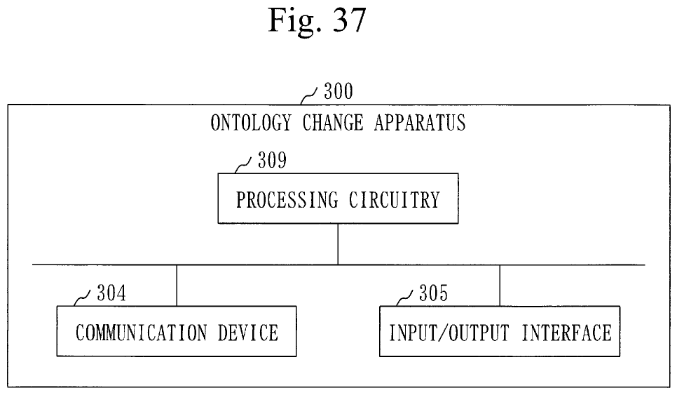

A hardware configuration of the ontology change apparatus 300 will be described with reference to FIG. 37.

The ontology change apparatus 300 includes a processing circuitry 309.

The processing circuitry 309 is hardware that realizes the usage statistics acquisition unit 311, the ontology reduction unit 312, the reduction result determination unit 313, the ontology expansion unit 314, and the expansion result determination unit 315.

The processing circuitry 309 may be dedicated hardware, or may be the processor 301 that executes a program stored in the memory 302.

When the processing circuitry 309 is the dedicated hardware, the processing circuitry 309 is, for example, a single circuit, a composite circuit, a programmed processor, a parallel-programmed processor, an ASIC, an FPGA, or a combination of these.

The ontology change apparatus 300 may include a plurality of processing circuitries that substitute for the processing circuitry 309. The plurality of processing circuitries share a role of the processing circuitry 309.

In the ontology change apparatus 300, a part of a function may be realized by the dedicated hardware, and the remaining function may be realized by software or firmware.

As described above, the processing circuitry 309 can be realized by the hardware, the software, the firmware, or a combination of these.

The embodiments are examples of preferred modes, and are not intended to limit the technical scope of the present invention. The embodiments may be implemented partially or may be implemented being combined with other modes. The procedures described using the flowcharts and the like may be changed as appropriate.

Each of the ontology generation apparatus 200 and the ontology change apparatus 300 may be realized by a plurality of apparatuses.

“Unit” which is an element of each of the ontology generation apparatus 200 and the ontology change apparatus 300 may be read as “process” or “step”.

“Cloud system” can be read as “first system. “Edge system” can be read as “second system”.

### REFERENCE SIGNS LIST

100: IoT system, 101: Internet, 102: intranet, 110: ontology generation system, 111: cloud system, 112: edge system, 113: sensor, 200: ontology generation apparatus, 201: processor, 202: memory, 203: auxiliary storage device, 204: communication device, 205: input/output interface, 209: processing circuitry, 211: similarity degree computation unit, 212: candidate extraction unit, 213: constraint determination unit, 214: ontology output unit, 221: similarity degree type selection unit, 231: morpheme analysis unit, 241: candidate synthesis unit, 290: storage unit, 291: cloud-system-oriented ontology, 292: benchmark data, 293: thesaurus data, 294: constraint data, 295: edge-system-oriented ontology, 296: similarity degree type data, 300: ontology change apparatus, 301: processor, 302: memory, 303: auxiliary storage device, 304: communication device, 305: input/output interface, 309: processing circuitry, 311: usage statistics acquisition unit, 312: ontology reduction unit, 313: reduction result determination unit, 314: ontology expansion unit, 315: expansion result determination unit, 390: storage unit, 391: constraint data, 392: statistics data.

1. An ontology generation system comprising:
first processing circuitry
to compute a similarity degree between each of one or more partial ontologies in a first-system-oriented ontology and a benchmark ontology of a second system, as a similarity degree of each of the partial ontologies;
to extract as an ontology candidate from the first-system-oriented ontology, a set of: each of partial ontologies having similarity degrees which satisfy a similarity degree condition; and a partial ontology for linking to each other the partial ontologies having the similarity degrees which satisfy the similarity degree condition;
to determine whether or not the ontology candidate satisfies a constraint condition; and
to output, when the ontology candidate satisfies the constraint condition, the ontology candidate as a second-system-oriented ontology.

2. The ontology generation system according to claim 1,
wherein the first processing circuitry
selects from a plurality of similarity degree types, a similarity degree type which accords to an operation environment of the second system, and
computes the similarity degree of each of the partial ontologies using a computation process which is for the selected similarity degree type.

3. The ontology generation system according to claim 1,
wherein the first processing circuitry
divides into one or more morphemes, each of a sentence in the benchmark ontology and a sentence in each of the partial ontologies, and
computes the similarity degree of each of the partial ontologies based on the one or more morphemes in the benchmark ontology and the one or more morphemes in each of the partial ontologies.

4. The ontology generation system according to claim 1,
wherein the first processing circuitry
computes the similarity degree of each of the partial ontologies, for each benchmark ontology of a plurality of benchmark ontologies,
extracts a plurality of ontology candidates corresponding to the plurality of benchmark ontologies,
generates, by synthesizing the plurality of ontology candidates, an ontology candidate-after-synthesis,
determines whether or not the ontology candidate-after-synthesis satisfies the constraint condition, and
outputs, when the ontology candidate-after-synthesis satisfies the constraint condition, the ontology candidate-after-synthesis, as the second-system-oriented ontology.

5. The ontology generation system according to claim 1,
wherein the second-system-oriented ontology is used in the second system, and
wherein the ontology generation system comprises second processing circuitry to delete, based on usage statistics of each of the partial ontologies in the second-system-oriented ontology, one or more partial ontologies from the second-system-oriented ontology.

6. The ontology generation system according to claim 1,
wherein the second-system-oriented ontology is used in the second system, and
wherein the ontology generation system comprises second processing circuitry to acquire, based on usage statistics of each of the partial ontologies in the second-system-oriented ontology, one or more partial ontologies from the first-system-oriented ontology, and add to the second-system-oriented ontology, the one or more partial ontologies acquired.

7. An ontology generation method comprising:
computing a similarity degree between each of one or more partial ontologies in a first-system-oriented ontology and a benchmark ontology of a second system, as a similarity degree of each of the partial ontologies;
extracting as an ontology candidate from the first-system-oriented ontology, a set of: each of partial ontologies having similarity degrees which satisfy a similarity degree condition; and a partial ontology for linking to each other the partial ontologies having the similarity degrees which satisfy the similarity degree condition;
determining whether or not the ontology candidate satisfies a constraint condition; and
outputting, when the ontology candidate satisfies the constraint condition, the ontology candidate as a second-system-oriented ontology.

8. A non-transitory computer readable medium storing an ontology generation program which causes a computer to execute:
a similarity degree computation process of computing a similarity degree between each of one or more partial ontologies in a first-system-oriented ontology and a benchmark ontology of a second system, as a similarity degree of each of the partial ontologies;
a candidate extraction process of extracting as an ontology candidate from the first-system-oriented ontology, a set of: each of partial ontologies having similarity degrees which satisfy a similarity degree condition; and a partial ontology for linking to each other the partial ontologies having the similarity degrees which satisfy the similarity degree condition;
a constraint determination process of determining whether or not the ontology candidate satisfies a constraint condition; and
an ontology output process of outputting, when the ontology candidate satisfies the constraint condition, the ontology candidate as a second-system-oriented ontology.
